(19) United States
(12) Patent Application Publication
(10) Pub. No.: US 2025/0153484 A1
(43) Pub. Date: May 15, 2025

(54) DROPLET DISCHARGE DEVICE AND MAINTENANCE METHOD

(71) Applicant: KYOCERA CORPORATION, Kyoto-shi, Kyoto (JP)

(72) Inventors: Makoto TOGO, Kagoshima-shi, Kagoshima (JP); Daisuke HOZUMI, Kirishima-shi, Kagoshima (JP)

(21) Appl. No.: 18/722,592

(22) PCT Filed: Dec. 23, 2022
(86) PCT No.: PCT/JP2022/047599

§ 371 Date: Jun. 21, 2024

(30) Foreign Application Priority Data
Dec. 23, 2021 (JP) 2021-209223

(51) Int. Cl. B41J 2/175; B41J 2/165; B41J 2/18

(52) U.S. Cl. CPC B41J 2/175; B41J 2/16526; B41J 2/18

(57) ABSTRACT

A droplet discharge device includes a droplet discharge head, a supply unit, and a controller. The droplet discharge head discharges droplets of a coloring liquid. The supply unit supplies the coloring liquid to the droplet discharge head. The controller controls each unit. During at least a part of a maintenance period after a discharge period in which droplets of the coloring liquid are discharged from the droplet discharge head, the controller controls the supply unit to supply the coloring liquid having a viscosity lower than that of the coloring liquid in the discharge period to the droplet discharge head.

### TECHNICAL FIELD

The disclosed embodiments relate to a droplet discharge device and a maintenance method.

### BACKGROUND OF INVENTION

Inkjet printers and inkjet plotters utilizing an inkjet recording method are known examples of printing apparatuses. A droplet discharge head for discharging liquid is installed in such printing apparatuses utilizing an inkjet method.

Also, in printing apparatuses utilizing an inkjet method, a technique has been proposed in which a cleaning liquid is supplied to a droplet discharge head to stop the droplet discharge head from clogging.

### CITATION LIST

### Patent Literature

Patent Document 1: JP 3629926 B

### SUMMARY

A droplet discharge device according to one aspect of an embodiment includes a droplet discharge head, a supply unit, and a controller. The droplet discharge head discharges droplets of a coloring liquid. The supply unit supplies the coloring liquid to the droplet discharge head. The controller controls each unit. During at least a part of a maintenance period after a discharge period in which droplets of the coloring liquid are discharged from the droplet discharge head, the controller controls the supply unit to supply the coloring liquid having a viscosity lower than that of the coloring liquid in the discharge period to the droplet discharge head.

### BRIEF DESCRIPTION OF THE DRAWINGS

FIG. 1 is a diagram schematically illustrating a configuration example of a droplet discharge device according to an embodiment.

FIG. 2 is a perspective view schematically illustrating an outer appearance configuration of a droplet discharge head according to the embodiment.

FIG. 3 is a plan view illustrating the droplet discharge head according to the embodiment.

FIG. 4 is a diagram schematically illustrating channels inside the droplet discharge head according to the embodiment.

FIG. 5 is a diagram schematically illustrating a configuration example of a discharge unit according to the embodiment.

FIG. 6 is a diagram schematically illustrating a circulation mechanism according to the embodiment.

FIG. 7 is a flowchart illustrating a processing procedure executed by the droplet discharge device according to the embodiment.

FIG. 8 is an explanatory diagram for describing a mode of adjusting the circulation flow rate according to the embodiment.

FIG. 9 is an explanatory diagram for describing a mode of adjusting the circulation flow rate according to Variation 1 of the embodiment.

FIG. 10 is an explanatory diagram for describing a mode of adjusting the circulation flow rate according to Variation 2 of the embodiment.

FIG. 11 is an explanatory diagram for describing a mode of adjusting the circulation flow rate according to Variation 3 of the embodiment.

FIG. 12 is an explanatory diagram for describing a mode of adjusting the circulation flow rate according to Variation 4 of the embodiment.

FIG. 13 is an explanatory diagram for describing a mode of adjusting the circulation flow rate according to Variation 5 of the embodiment.

FIG. 14 is a diagram schematically illustrating an example of a posture of the droplet discharge head according to Variation 5 of the embodiment.

FIG. 15 is an explanatory diagram for describing a mode of adjusting the circulation flow rate according to Variation 6 of the embodiment.

FIG. 16 is an explanatory diagram for describing a mode of adjusting the circulation flow rate according to Variation 7 of the embodiment.

FIG. 17 is a diagram illustrating propagation of a pressure wave according to Variation 7 of the embodiment.

FIG. 18 is an explanatory diagram for describing an internal configuration of the droplet discharge head according to Variation 8 of the embodiment and a mode of circulating a coloring liquid.

FIG. 19 is an explanatory diagram for describing the internal configuration of the droplet discharge head according to Variation 8 of the embodiment and the mode of circulating the coloring liquid.

### DESCRIPTION OF EMBODIMENTS

Hereinafter, embodiments of a droplet discharge device and a maintenance method that are disclosed in the present application will be described with reference to the accompanying drawings. The present disclosure is not limited by the following embodiments. Note that the drawings are schematic and that the dimensional relationships between elements, the proportions of the elements, and the like may differ from the actual ones. There may be differences between the drawings in terms of dimensional relationships, proportions, and the like.

In the embodiments described below, expressions such as “constant”, “orthogonal”, “perpendicular”, and “parallel” may be used, but these expressions do not mean exactly “constant”, “orthogonal”, “perpendicular”, and “parallel”. In other words, it is assumed that the above expressions allow for deviations in manufacturing accuracy, installation accuracy, or the like.

Embodiments can be appropriately combined so as not to contradict each other in terms of processing content. In the following embodiments, the same portions are denoted by the same reference signs, and redundant explanations are omitted.

The droplet discharge device disclosed in the present application can be applied to inkjet printers and inkjet plotters that utilize an inkjet recording method, as well as devices that discharge droplets using an inkjet method.

### Example of Outer Appearance Configuration of Droplet Discharge Device

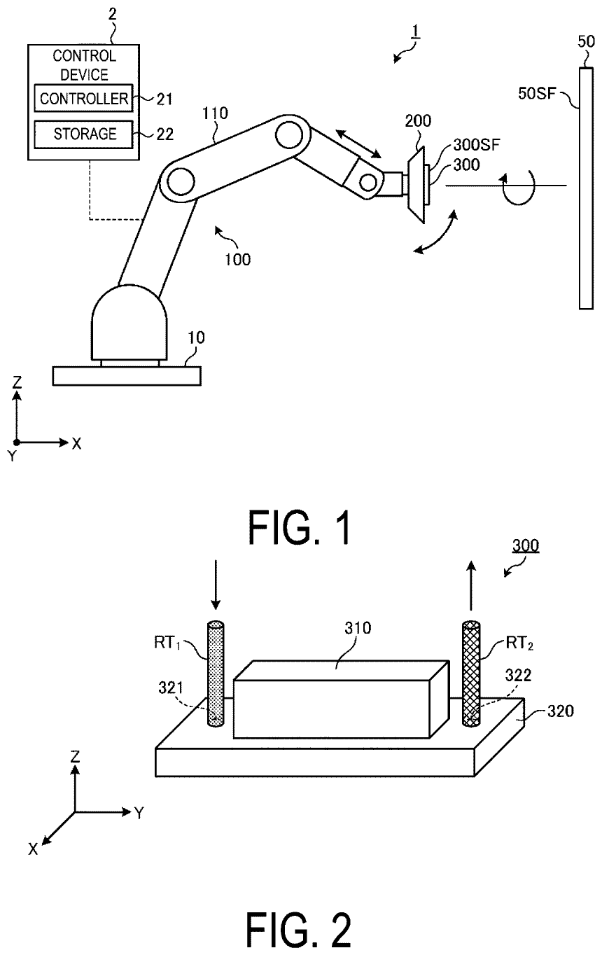

A configuration of a droplet discharge device according to an embodiment will be described with reference to FIG. 1. FIG. 1 is a diagram schematically illustrating a configuration example of the droplet discharge device according to the embodiment.

As illustrated in FIG. 1, a droplet discharge device 1 includes a robotic arm 100, a circulation mechanism 200, a droplet discharge head 300, and a control device 2.

The robotic arm 100 is assembled on a base 10 mounted on, for example, a horizontal floor surface indoors or outdoors. The robotic arm 100 includes an arm portion 110. The arm portion 110 is made up of a plurality of parts that are bent and stretched and rotatably assembled. In response to a command from a controller 21 described below, the arm portion 110 can, for example, move the droplet discharge head 300 mounted on a tip of the arm portion 110 and change the position, posture, and angle of the droplet discharge head 300. The arm portion 110 illustrated in FIG. 1 is not particularly limited to the configuration illustrated in FIG. 1 as long as the arm portion 110 is provided with a degree of freedom with which the droplet discharge head 300 can change the movement, position, posture, angle, and the like as necessary.

The robotic arm 100 can be moved in a vertical direction (Z axis direction) by the arm portion 110, which, for example, moves the circulation mechanism 200 and the droplet discharge head 300 that are mounted on the tip of the arm portion 110 along a predetermined axis of rotation. This allows the circulation mechanism 200 and the droplet discharge head 300 to, for example, assume a posture in which, as illustrated in FIG. 1, a liquid discharge surface 30SF of the droplet discharge head 300 faces parallel to a spraying surface 50SF of an object 50. The robotic arm 100 can, by the arm portion 110, rotate the circulation mechanism 200 and the droplet discharge head 300 that are assembled on the tip of the arm portion 110 about a predetermined axis of rotation, for example. This allows the circulation mechanism 200 and the droplet discharge head 300 to, for example, switch position in a longitudinal direction and in a lateral direction, or to invert an upper position and a lower position.

The circulation mechanism 200 is installed at a tip portion of the arm portion 110 of the robotic arm 100. The circulation mechanism 200 supplies a coloring liquid to the droplet discharge head 300 while controlling the circulation flow rate of the coloring liquid circulating between the circulation mechanism 200 and the droplet discharge head 300. The circulation mechanism 200 functions as a supply unit that supplies the coloring liquid to the droplet discharge head 300.

The droplet discharge head 300 is assembled on the circulation mechanism 200 installed at the tip portion of the arm portion 110 of the robotic arm 100. The droplet discharge head 300 functions as a droplet discharge unit that discharges droplets of the coloring liquid to the object 50. The coloring liquid is liquid that can be applied to the object 50 to color the object 50. A case in which the coloring liquid is a pseudoplastic fluid whose viscosity decreases as the shear rate increases is described as an example, but the coloring liquid may not be a pseudoplastic fluid. For example, ink, paint, or the like can be used as the coloring liquid.

The control device 2 is, for example, a computer, and includes the controller 21 such as a processor and a storage 22 such as a memory. A control program for controlling a variety of processing to be executed in the droplet discharge device 1 is stored in the storage 22. The controller 21 reads out the program stored in the storage 22 and executes the program, thereby controlling the operation of the droplet discharge device 1.

The program may be recorded in a computer-readable storage medium and installed in the storage 22 of the control device 2 from the storage medium. Examples of the computer-readable storage medium include a hard disk (HD), a flexible disk (FD), a compact disk (CD), a magneto-optical disk (MO), and a memory card.

Incidentally, after droplets of the coloring liquid are discharged, various residue may remain in the droplet discharge head 300. Examples of the residue include solidified substances of the coloring liquid and air bubbles. When the residue remains in the droplet discharge head 300, the flow of the coloring liquid is disturbed, and thus discharge failure of the droplet discharge head 300 may occur. In view of this point, the present application proposes the droplet discharge device 1 that can reduce the likelihood of discharge failure caused by residue remaining in the droplet discharge head 300.

### Configuration Example of Droplet Discharge Head

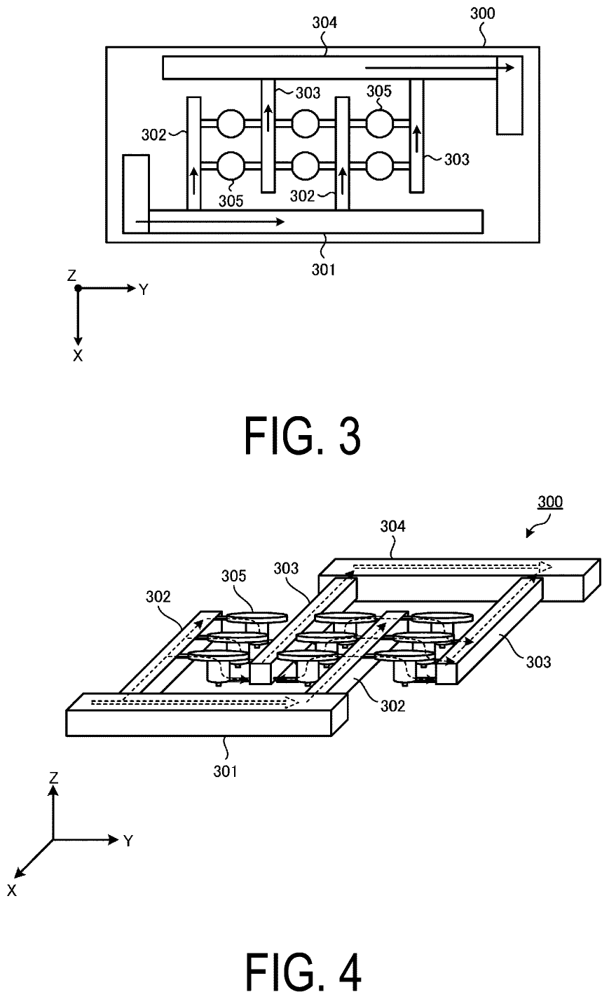

The droplet discharge head 300 according to the embodiment will be described with reference to FIGS. 2 to 4. FIG. 2 is a perspective view schematically illustrating an outer appearance configuration of the droplet discharge head according to the embodiment. FIG. 3 is a plan view of the droplet discharge head according to the embodiment. FIG. 4 is a diagram schematically illustrating channels inside the droplet discharge head according to the embodiment.

As illustrated in FIG. 2, the droplet discharge head 300 includes a housing including a box-shaped member 310 and a substantially plate-shaped member 320. The housing of the droplet discharge head 300 is provided with a supply port 321 for supplying the coloring liquid to the inside of the droplet discharge head 300 and a recovery port 322 for recovering the coloring liquid from the inside of the droplet discharge head 300. A first channel RT₁ for supplying the coloring liquid from the circulation mechanism 200 to the inside of the head is connected to the supply port 321. A second channel RT₂ for sending the coloring liquid recovered within the head back to the circulation mechanism 200 is connected to the recovery port 322.

As illustrated in FIG. 3, the droplet discharge head 300 includes a supply reservoir 301, a supply manifold 302, a recovery manifold 303, a recovery reservoir 304, and a discharge unit 305.

The supply reservoir 301 has an elongated shape extending in a longitudinal direction (Y axis direction) of the droplet discharge head 300 and connects to the supply manifold 302. The supply reservoir 301 includes a channel therein. As illustrated in FIG. 4, the coloring liquid supplied through the first channel RT₁ and the supply port 321 to the supply reservoir 301 and stored in the channel of the supply reservoir 301 is delivered to the supply manifold 302.

The supply manifold 302 has an elongated shape extending in a lateral direction (X axis direction) of the droplet discharge head 300 to a position before the recovery reservoir 304. The supply manifold 302 includes a channel therein in communication with the channel included in the supply reservoir 301 and with the discharge unit 305. As illustrated in FIG. 4, the coloring liquid delivered from the supply reservoir 301 to the supply manifold 302 is fed from the supply manifold 302 to the discharge unit 305.

The recovery manifold 303 has an elongated shape extending in the lateral direction (X axis direction) of the droplet discharge head 300 to a position before the supply reservoir 301. The recovery manifold 303 has a channel therein in communication with the channel included in the recovery reservoir 304 and with the discharge unit 305. As illustrated in FIG. 4, the coloring liquid that has not been discharged from the discharge unit 305 to the outside is fed into the recovery manifold 303.

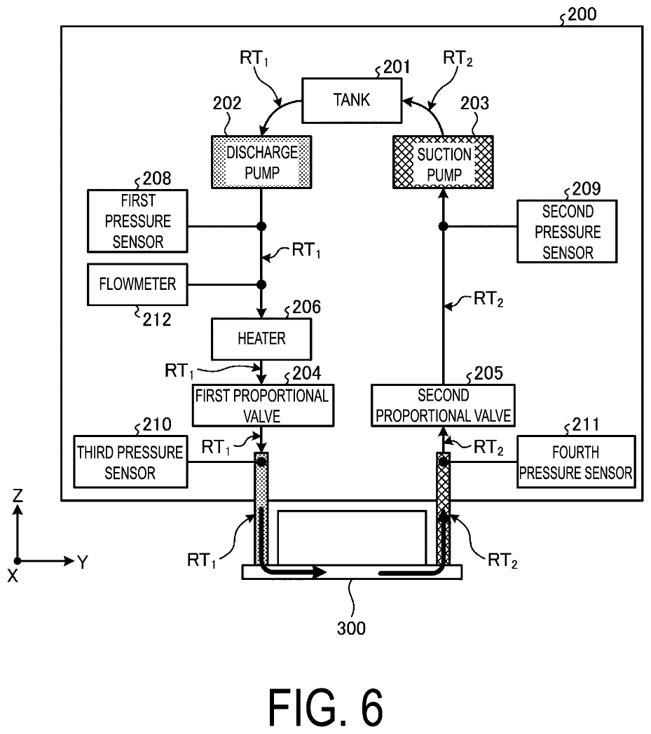

The recovery reservoir 304 has an elongated shape extending in the longitudinal direction (Y axis direction) of the droplet discharge head 300 and is connected to the recovery manifold 303. The recovery reservoir 304 includes a channel therein. As illustrated in FIG. 4, the coloring liquid fed from the recovery manifold 303 to the recovery reservoir 304 and stored in the channel of the recovery reservoir 304 is fed back through the recovery port 322 and the second channel RT₂ to a tank 201 (see FIG. 6).

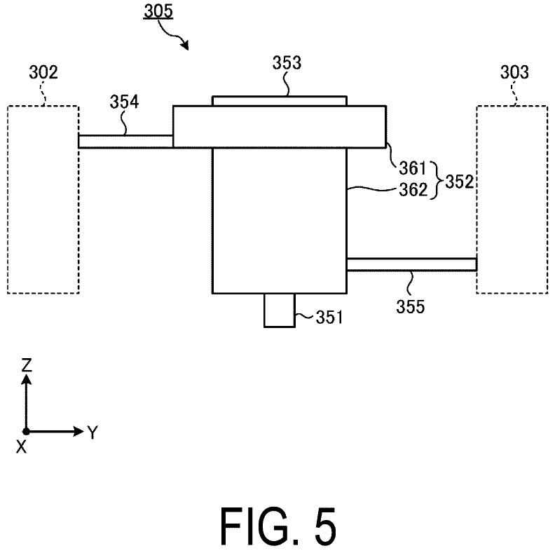

FIG. 5 is a diagram schematically illustrating a configuration example of the discharge unit according to the embodiment. As illustrated in FIG. 5, the discharge unit 305 includes a nozzle 351, a pressurizing chamber 352, and a displacement element 353. The nozzle 351 is a discharge hole that is open to the discharge surface 30SF (see FIG. 1) of the droplet discharge head 300.

The pressurizing chamber 352 is connected to the nozzle 351. The pressurizing chamber 352 includes a body portion 361 to which pressure is applied by the displacement element 353, and a descender 362 serving as a channel connecting the body portion 361 and the nozzle 351. The pressurizing chamber 352 and the supply manifold 302 are connected to each other via a separate supply channel 354. The coloring liquid delivered from the supply manifold 302 to the discharge unit 305 is supplied through the separate supply channel 354 to the pressurizing chamber 352. The pressurizing chamber 352 and the recovery manifold 303 are connected to each other via a separate recovery channel 355. The coloring liquid that has not been discharged from the nozzle 351 to the outside is recovered from the pressurizing chamber 352 to the recovery manifold 303.

The displacement element 353 is located on a surface of the body portion 361 of the pressurizing chamber 352 on a side opposite to the descender 362. The displacement element 353 is an element that deforms in response to a predetermined driving signal. The displacement element 353 functions as a pressurizing unit that applies pressure to the pressurizing chamber 352 to discharge droplets of the coloring liquid from the nozzle 351. That is, when the displacement element 353 is deformed, pressure (positive pressure and negative pressure) is applied to the pressurizing chamber 352, and droplets of the coloring liquid are discharged from the nozzle 351. The displacement element 353 is electrically connected to the control device 2 and is controlled by the control device 2.

The discharge unit 305 having such a configuration sucks out the coloring liquid from the supply manifold 302 by the negative pressure applied to the pressurizing chamber 352, and discharges the sucked coloring liquid from the nozzle 351 toward the object 50 by the positive pressure applied to the pressurizing chamber 352.

### Configuration Example of Circulation Mechanism

Next, a configuration example of the circulation mechanism 200 according to the embodiment will be described. FIG. 6 is a diagram schematically illustrating the circulation mechanism according to the embodiment.

As illustrated in FIG. 6, the circulation mechanism 200 includes a tank 201, a discharge pump 202, a suction pump 203, a first proportional valve 204, a second proportional valve 205, and a heater 206. The circulation mechanism 200 also includes a first pressure sensor 208, a second pressure sensor 209, a third pressure sensor 210, a fourth pressure sensor 211, and a flowmeter 212.

The circulation mechanism 200 also includes the first channel RT₁ and the second channel RT₂. The first channel RT₁ is a channel that connects the tank 201 and the droplet discharge head 300 to cause the coloring liquid stored in the tank 201 to flow into the droplet discharge head 300. The second channel RT₂ is a channel that connects the tank 201 and the droplet discharge head 300 to cause the coloring liquid that has flowed into the droplet discharge head 300 to return to the tank 201. The coloring liquid recovered within the droplet discharge head 300 without being discharged from the droplet discharge head 300 to the outside is sent back through the second channel RT₂ to the tank 201. The first channel RT₁ and the second channel RT₂ can be implemented, for example, by a pipe made of a predetermined material that does not interact with constituents of the coloring liquid. As illustrated in FIG. 6, for example, the circulation mechanism 200 having such components controls the circulation flow rate of the coloring liquid circulating clockwise between the tank 201 and the droplet discharge head 300 in accordance with control by the controller 21.

The tank 201 stores the coloring liquid supplied to the droplet discharge head 300. The tank 201 functions as a storage for storing the coloring liquid supplied to the droplet discharge head 300.

The discharge pump 202 feeds the coloring liquid stored in the tank 201 to the droplet discharge head 300 through the first channel RT1. The discharge pump 202 generates positive pressure for feeding the coloring liquid stored in the tank 201 to the droplet discharge head 300. The discharge pump 202 can, for example, feed the coloring liquid stored in the tank 201 to the droplet discharge head 300 at a predetermined constant supply pressure.

The suction pump 203 feeds the coloring liquid recovered in the droplet discharge head 300 to the tank 201 through the second channel RT2. The suction pump 203 sucks the coloring liquid recovered in the droplet discharge head 300 to generate negative pressure for sending the coloring liquid back to the tank 201. The suction pump 203 can, for example, feed the coloring liquid sucked from the droplet discharge head 300 to the tank 201 at a predetermined constant recovery pressure.

The discharge pump 202 and the suction pump 203 can be implemented by a rotary pump such as a gear pump or a displacement pump such as a diaphragm pump.

The first proportional valve 204 is interposed in the first channel RT₁ between the tank 201 and the droplet discharge head 300 to proportionally control the flow rate of the coloring liquid supplied to the droplet discharge head 300. The first proportional valve 204 can continuously modify the channel cross-sectional area for the coloring liquid between 0 to 100%, and controls the flow rate of the coloring liquid to a desired flow rate. For example, the first proportional valve 204 can reduce the supply flow rate when supplying the coloring liquid to the droplet discharge head 300 by reducing the channel cross-sectional area for the coloring liquid. On the other hand, the first proportional valve 204 can increase the supply flow rate when supplying the liquid to the droplet discharge head 300 by increasing the channel cross-sectional area for the liquid.

The second proportional valve 205 is interposed in the second channel RT₂ between the tank 201 and the droplet discharge head 300 to proportionally control the flow rate of the coloring liquid fed from the droplet discharge head 300 to the tank 201. As with the first proportional valve 204, the second proportional valve 205 can continuously modify the channel cross-sectional area for the liquid between 0 to 100%, and controls the flow rate of the coloring liquid to a desired flow rate. For example, the second proportional valve 205 can reduce the recovery flow rate when recovering the coloring liquid from the droplet discharge head 300 by reducing the channel cross-sectional area for the coloring liquid. On the other hand, the second proportional valve 205 can increase the recovery flow rate when recovering the coloring liquid from the droplet discharge head 300 by increasing the channel cross-sectional area for the coloring liquid.

The first proportional valve 204 and the second proportional valve 205 can be implemented by a proportional selector valve of an electromagnetic type or a proportional selector valve of a pneumatic type.

The heater 206 is provided in the first channel RT₁ or adjacent to the first channel RT₁, and heats the coloring liquid flowing through the first channel RT₁.

The first pressure sensor 208 measures the pressure of the coloring liquid fed by the discharge pump 202 from the tank 201 to the droplet discharge head 300. The first pressure sensor 208 measures the pressure downstream of the discharge pump 202 in a circulation direction of the coloring liquid in the circulation mechanism 200. The first pressure sensor 208 sends the measurement results to the controller 21.

The second pressure sensor 209 measures the pressure of the coloring liquid that is sucked from the droplet discharge head 300 by the suction pump 203 and fed to the tank 201. The second pressure sensor 209 measures the pressure upstream of the suction pump 203 in the circulation direction of the coloring liquid in the circulation mechanism 200. The second pressure sensor 209 sends the measurement results to the controller 21.

The third pressure sensor 210 functions as a first pressure measuring unit that measures the pressure of the coloring liquid flowing between the first proportional valve 204 and the droplet discharge head 300 through the first channel RT₁ as the supply pressure. The third pressure sensor 210 sends the measurement results to the controller 21.

The fourth pressure sensor 211 functions as a second pressure measuring unit that measures the pressure of the coloring liquid flowing between the second proportional valve 205 and the droplet discharge head 300 through the second channel RT₂ as the recovery pressure. The fourth pressure sensor 211 sends the measurement results to the controller 21.

The flowmeter 212 measures the flow rate of the coloring liquid fed to the droplet discharge head 300. The flowmeter 212 sends the measurement results to the controller 21.

### Control of Pump

The controller 21 makes an adjustment to keep constant the positive pressure applied to the coloring liquid that the discharge pump 202 feeds, in accordance with the measurement result of the first pressure sensor 208 and the measurement result of the third pressure sensor 210. For example, the controller 21 adjusts the positive pressure of the discharge pump 202 such that the pressure of the coloring liquid obtained from the measurement result of the measurement result of the first pressure sensor 208 remains approximately 1.2 to 3 times larger than the pressure of the coloring liquid obtained from the measurement result of the third pressure sensor 210.

The controller 21 also makes an adjustment to keep constant the negative pressure applied to the coloring liquid that the suction pump 203 sucks, in accordance with the measurement result of the second pressure sensor 209 and the fourth pressure sensor 211. For example, the controller 21 adjusts the negative pressure of the suction pump 203 such that the pressure of the coloring liquid obtained from the measurement result of the measurement result of the second pressure sensor 209 remains approximately 1.2 to 3 times lower than the pressure of the coloring liquid obtained from the measurement result of the fourth pressure sensor 211.

The controller 21 circulates the coloring liquid between the tank 201 and the droplet discharge head 300 by adjusting and keeping constant the differential pressure between the positive pressure that the discharge pump 202 applies to the coloring liquid and the negative pressure that the suction pump 203 applies to the coloring liquid.

### Specific Operation of Droplet Discharge Device

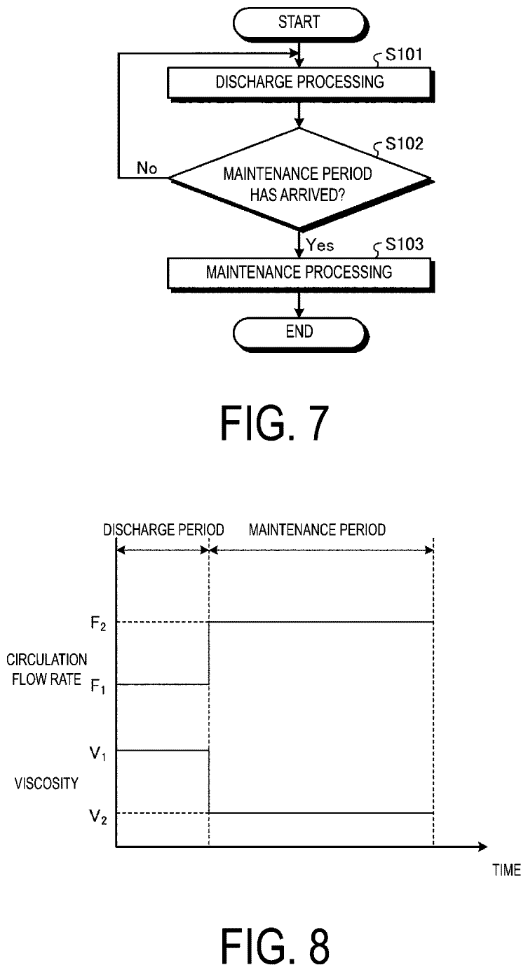

Next, a specific operation of the droplet discharge device according to the embodiment will be described with reference to FIG. 7. FIG. 7 is a flowchart illustrating a processing procedure executed by the droplet discharge device according to the embodiment. Each step of processing illustrated in FIG. 7 is executed in accordance with control of the controller 21.

As illustrated in FIG. 7, in the droplet discharge device 1, first, discharge processing of discharging droplets of the coloring liquid from the droplet discharge head 300 is performed (step S101). In the discharge processing, the controller 21 controls the displacement element 353 included in the droplet discharge head 300 to apply pressure to the pressurizing chamber 352, and thus the coloring liquid is discharged from the nozzle 351 toward the object 50. Hereinafter, a cumulative processing period during which the discharge processing is performed is referred to as a “discharge period”.

Before starting the discharge processing, the controller 21 controls the discharge pump 202 and the suction pump 203 to start the circulation of the coloring liquid between the tank 201 and the droplet discharge head 300.

Subsequently, in the droplet discharge device 1, whether a maintenance period for performing maintenance processing of the droplet discharge head 300 has arrived is determined (step S102). The determination in step S102 is made based on, for example, whether the discharge period exceeds a predetermined period. In a case where the maintenance period has not yet arrived (step S102; No), the processing returns to step S101, and the discharge processing is continuously performed.

On the other hand, in a case where the maintenance period has arrived (step S102; Yes), the maintenance processing of the droplet discharge head 300 is performed (step S103). In the maintenance processing, the controller 21 controls the circulation mechanism 200 to adjust the circulation flow rate of the coloring liquid circulating between the circulation mechanism 200 and the droplet discharge head 300. A mode of adjusting the circulation flow rate of the coloring liquid circulating between the circulation mechanism 200 and the droplet discharge head 300 will be described below. When the maintenance processing is finished, the controller 21 finishes the series of processing in the droplet discharge device 1.

### Mode of Adjusting Circulation Flow Rate

Hereinafter, a mode of adjusting the circulation flow rate of the coloring liquid circulating between the circulation mechanism 200 and the droplet discharge head 300 will be described with reference to FIG. 8. FIG. 8 is an explanatory diagram for describing a mode of adjusting the circulation flow rate according to the embodiment.

FIG. 8 shows temporal changes of “circulation flow rate” and “viscosity” in the discharge period and the maintenance period. The “circulation flow rate” refers to the circulation flow rate of the coloring liquid circulating between the circulation mechanism 200 and the droplet discharge head 300, and the “viscosity” refers to the viscosity of the coloring liquid supplied from the circulation mechanism 200 to the droplet discharge head 300.

As shown in FIG. 8, during the maintenance period after the discharge period, the controller 21 controls the circulation mechanism 200 to increase the circulation flow rate of the coloring liquid to be higher than the circulation flow rate of the coloring liquid in the discharge period. Here, as described above, the coloring liquid is a pseudoplastic fluid whose viscosity decreases as the shear rate increases. As the circulation flow rate of the coloring liquid increases, the shear rate of the coloring liquid with respect to the circulation direction increases and the viscosity of the coloring liquid decreases. Accordingly, by increasing the circulation flow rate of the coloring liquid during the maintenance period, the controller 21 can supply the coloring liquid having a viscosity lower than that of the coloring liquid in the discharge period to the droplet discharge head 300.

For example, the controller 21 changes the channel cross-sectional areas of the first proportional valve 204 and the second proportional valve 205 in the circulation mechanism 200 to change the supply flow rate and the recovery flow rate of the coloring liquid, thereby increasing the circulation flow rate from a circulation flow rate F₁ of the coloring liquid in the discharge period to a circulation flow rate F₂ (>F₁). Thus, during the maintenance period, the controller 21 can reduce the viscosity of the coloring liquid supplied to the droplet discharge head 300 from a viscosity V₁ of the coloring liquid in the discharge period to a viscosity V₂ (<V₁).

As described above, during the maintenance period after the discharge period, the circulation flow rate of the coloring liquid is increased to be higher than the circulation flow rate of the coloring liquid in the discharge period, and thus the viscosity of the coloring liquid can be reduced compared to the viscosity of the coloring liquid in the discharge period.

With the droplet discharge device 1 according to the embodiment, even when solidified substances or air bubbles of the coloring liquid remain in the droplet discharge head 300, the viscosity of the coloring liquid can be reduced such that the residue can be easily peeled off from the inner wall of the channel within the droplet discharge head 300. Consequently, since the residue is smoothly discharged to the outside of the droplet discharge head 300, the residue are less likely to disturb the flow of the coloring liquid in the channel within the droplet discharge head 300. As a result, discharge failure caused by residue remaining in the droplet discharge head 300 can be suppressed.

In the example illustrated in FIG. 8, the circulation flow rate of the coloring liquid is increased during the entire maintenance period to be higher than the circulation flow rate of the coloring liquid in the discharge period, but the circulation flow rate of the coloring liquid may be increased during a part of the maintenance period. In short, the controller 21 may control the circulation mechanism 200 during at least a part of the maintenance period to increase the circulation flow rate of the coloring liquid to be higher than the circulation flow rate of the coloring liquid in the discharge period.

### Various Variations of Mode of Adjusting Circulation Flow Rate

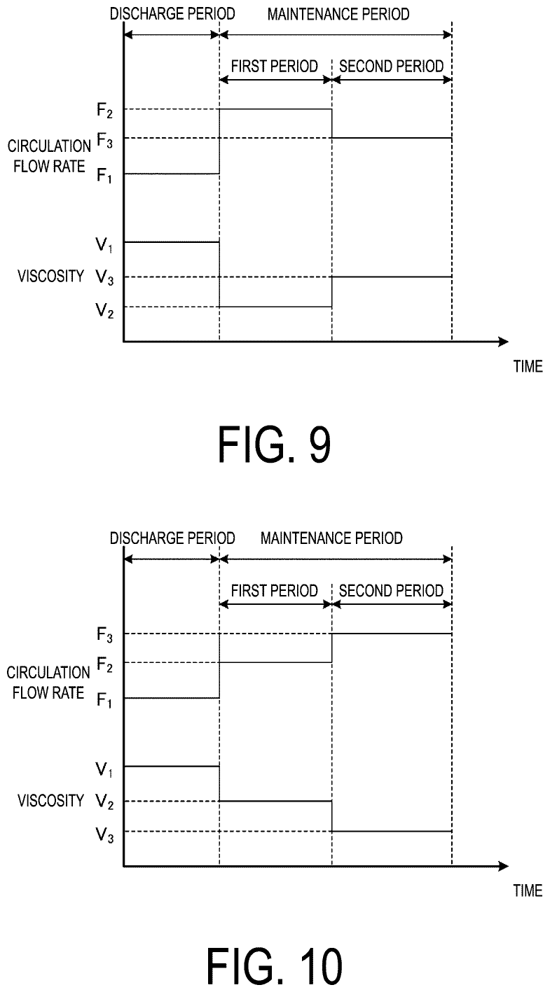

Next, various variations of the mode of adjusting the circulation flow rate according to the embodiment will be described with reference to FIGS. 9 to 17.

FIG. 9 is an explanatory diagram for describing a mode of adjusting the circulation flow rate according to Variation 1 of the embodiment.

As shown in FIG. 9, the controller 21 controls the circulation mechanism 200 to change the circulation flow rate of the coloring liquid between a first period and a second period subsequent to the first period, which are included in the maintenance period. Accordingly, the controller 21 can change the viscosity of the coloring liquid between the first period and the second period subsequent to the first period, which are included in the maintenance period.

For example, the controller 21 changes the channel cross-sectional areas of the first proportional valve 204 and the second proportional valve 205 in the circulation mechanism 200 to change the supply flow rate and the recovery flow rate of the coloring liquid, thereby setting the circulation flow rate to the circulation flow rate F₂ in the first period and to a circulation flow rate F₃ (<F₂) in the second period. Thus, the controller 21 can set the viscosity of the coloring liquid supplied to the droplet discharge head 300 to the viscosity V₂ in the first period and to a viscosity V₃ (>V₂) in the second period.

As described above, in Variation 1, by changing the circulation flow rate of the coloring liquid, the coloring liquid having a relatively low viscosity and the coloring liquid having a relatively high viscosity can be supplied to the droplet discharge head 300. As a result, in Variation 1, the residue can be peeled off from the inner wall of the channel within the droplet discharge head 300 by the coloring liquid having a relatively low viscosity, and the residue remaining in the droplet discharge head 300 can be washed away by the coloring liquid having a relatively high viscosity.

In Variation 1, the circulation flow rate of the coloring liquid is changed from a relatively high flow rate (e.g., the circulation flow rate F₂) to a relatively low flow rate (e.g., the circulation flow rate F₃). Thus, in Variation 1, after the coloring liquid having a relatively low viscosity is supplied to the droplet discharge head 300, the coloring liquid having a relatively high viscosity can be supplied to the droplet discharge head 300. In other words, the residue is peeled off from the inner wall of the channel within the droplet discharge head 300 by the coloring liquid having a relatively low viscosity, and then the residue remaining in the droplet discharge head 300 can be washed away by the coloring liquid having a relatively high viscosity. As a result, according to Variation 1, the residue can be more smoothly discharged to the outside of the droplet discharge head 300.

FIG. 10 is an explanatory diagram for describing a mode of adjusting the circulation flow rate according to Variation 2 of an embodiment. In Variation 1, the circulation flow rate of the coloring liquid is changed from a relatively high flow rate to a relatively low flow rate. Meanwhile, in Variation 2, the circulation flow rate of the coloring liquid is changed from a relatively low flow rate to a relatively high flow rate.

As shown in FIG. 10, the controller 21 controls the circulation mechanism 200 to set the circulation flow rate to the circulation flow rate F₂ in the first period and to set the circulation flow rate to the circulation flow rate F₃ (>F₂) in the second period. Thus, the controller 21 can set the viscosity of the coloring liquid supplied to the droplet discharge head 300 to the viscosity V₂ in the first period and to the viscosity V₃ (<V₂) in the second period.

As described above, in Variation 2, the circulation flow rate of the coloring liquid is changed from a relatively low flow rate (e.g., the circulation flow rate F₂) to a relatively high flow rate (e.g., the circulation flow rate F₃). Thus, in Variation 1, after the coloring liquid having a relatively high viscosity is supplied to the droplet discharge head 300, the coloring liquid having a relatively low viscosity can be supplied to the droplet discharge head 300. In other words, the residue remaining in the droplet discharge head 300 is washed away by the coloring liquid having a relatively high viscosity, and then the residue can be transported at high speed to the downstream side of the channel within the droplet discharge head 300 by the coloring liquid having a relatively low viscosity. As a result, according to Variation 1, the residue can be more smoothly discharged to the outside of the droplet discharge head 300.

In Variation 1 and Variation 2, the circulation flow rate of the coloring liquid is changed once in the first period and the second period subsequent to the first period, which are included in the maintenance period; however, the disclosed technique is not limited thereto. For example, the controller 21 may control the circulation mechanism 200 to perform processing of changing the circulation flow rate of the coloring liquid repeatedly more than once during the maintenance period.

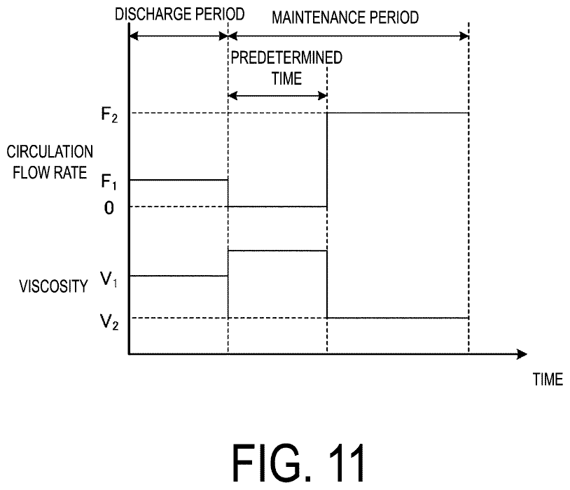

FIG. 11 is an explanatory diagram for describing a mode of adjusting the circulation flow rate according to Variation 3 of the embodiment. Solidified substances of the coloring liquid (hereinafter, appropriately referred to as “solidified substances”) remain as residue in the droplet discharge head 300. In contrast, in Variation 3, the coloring liquid contains a dissolving component capable of dissolving the solidified substances of the coloring liquid, and the solidified substances remaining in the droplet discharge head 300 are dissolved by the dissolving component.

As shown in FIG. 11, during the maintenance period, the controller 21 controls the

circulation mechanism 200 to stop the circulation of the coloring liquid for a predetermined time for allowing the solidified substances remaining in the droplet discharge head 300 to be dissolved in the dissolving component, and to then increase the circulation flow rate of the coloring liquid.

For example, the controller 21 changes the channel cross-sectional areas of the first proportional valve 204 and the second proportional valve 205 in the circulation mechanism 200 to 0 to stop the circulation of the coloring liquid for a period time, thereby setting the circulation flow rate to 0. When the predetermined time has elapsed, the controller 21 increases the channel cross-sectional areas of the first proportional valve 204 and the second proportional valve 205 in the circulation mechanism 200 to be larger than 0, thereby increasing the circulation flow rate to the circulation flow rate F₂ that is higher than the circulation flow rate F₁ of the coloring liquid in the discharge period. Thus, after the predetermined time has elapsed, the controller 21 can reduce the viscosity of the coloring liquid supplied to the droplet discharge head 300 to the viscosity V₂ that is lower than the viscosity V₁ of the coloring liquid in the discharge period.

As described above, in Variation 3, the circulation of the coloring liquid is stopped for a predetermined time before the circulation flow rate of the coloring liquid is increased. Thus, in Variation 3, the solidified substances remaining in the droplet discharge head 300 can be dissolved in the dissolving component contained in the coloring liquid, and then the solidified substances that have been dissolved can be transported at high speed by the coloring liquid to the downstream side of the channel within the droplet discharge head 300. As a result, according to Variation 3, the solidified substances of the coloring liquid can be more smoothly discharged to the outside of the droplet discharge head 300.

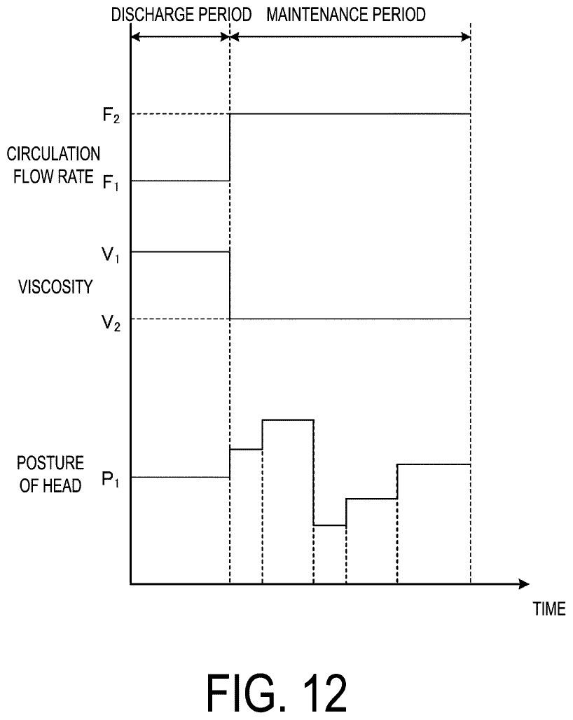

FIG. 12 is an explanatory diagram for describing a mode of adjusting the circulation flow rate according to Variation 4 of the embodiment. FIG. 12 shows temporal changes of the “head posture” in the discharge period and the maintenance period. The “head posture” refers to the posture of the droplet discharge head 300 mounted on the robotic arm 100.

As shown in FIG. 12, during the maintenance period after the discharge period, the controller 21 controls the circulation mechanism 200 to increase the circulation flow rate of the coloring liquid, and controls the robotic arm 100 to change the posture of the droplet discharge head 300.

For example, the controller 21 changes the channel cross-sectional areas of the first proportional valve 204 and the second proportional valve 205 in the circulation mechanism 200 to change the supply flow rate and the recovery flow rate of the coloring liquid, thereby increasing the circulation flow rate from the circulation flow rate F₁ of the coloring liquid in the discharge period to the circulation flow rate F₂ (>F₁). Thus, during the maintenance period, the controller 21 can reduce the viscosity of the coloring liquid supplied to the droplet discharge head 300 from the viscosity V₁ of the coloring liquid during the discharge period to the viscosity V₂ (<V₁).

For example, the controller 21 maintains the posture of the droplet discharge head 300 in a constant posture P₁ during the discharge period, and operates the arm portion 110 of the robotic arm 100 during the maintenance period, thereby sequentially changing the posture of the droplet discharge head 300 to a plurality of random postures.

As described above, in Variation 4, since the posture of the droplet discharge head 300 is changed during the maintenance period after the discharge period, the inclination of the droplet discharge head 300 with respect to the direction of gravitational force can be changed. The solidified substances of the coloring liquid remaining in the droplet discharge head 300 tend to move in the direction of gravitational force under the force of gravity. Air bubbles remaining in the droplet discharge head 300 tend to move in the opposite direction to the direction of gravitational force while subject to buoyancy. Accordingly, in Variation 4, when the posture of the droplet discharge head 300 is changed, the residue such as solidified substances or air bubbles of the coloring liquid remaining in the droplet discharge head 300 can be efficiently moved in the opposite direction to the direction of gravitational force. As a result, in Variation 4, the movement of the residue in the direction of gravitational force and the direction opposite to the direction of gravitational force can be promoted, and thus the residue can be smoothly discharged to the outside of the droplet discharge head 300.

In Variation 4, the posture of the droplet discharge head 300 is changed at the timing when the circulation flow rate of the coloring liquid is increased. In other words, in Variation 4, the timing when the change in posture of the droplet discharge head 300 is started is matched with the timing when the circulation flow rate of the coloring liquid is increased. As a result, in Variation 4, the movement of the residue in the direction of gravitational force and the direction opposite to the direction of gravitational force can be further promoted, and thus the residue can be smoothly discharged to the outside of the droplet discharge head 300.

In the example shown in FIG. 12, the posture of the droplet discharge head 300 is changed during the entire maintenance period, but the posture of the droplet discharge head 300 may be changed during a part of the maintenance period. In short, during at least a part of the maintenance period, the controller 21 may control the circulation mechanism 200 to increase the circulation flow rate of the coloring liquid, and may control the robotic arm 100 to change the posture of the droplet discharge head 300.

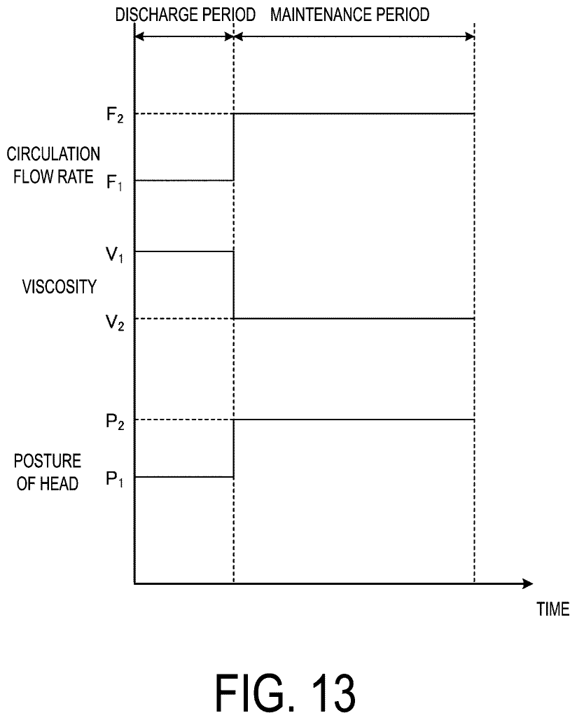

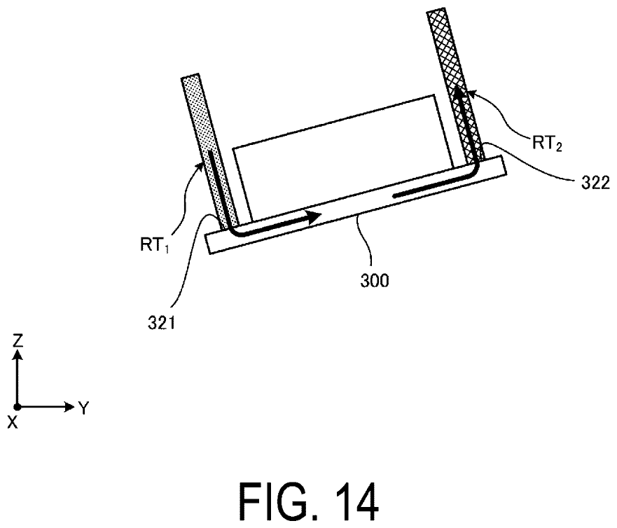

FIG. 13 is an explanatory diagram for describing a mode of adjusting the circulation flow rate according to Variation 5 of the embodiment. FIG. 14 is a diagram schematically illustrating an example of the posture of the droplet discharge head according to Variation 5 of the embodiment. Variation 5 relates to a variation of the posture change of the droplet discharge head 300 in Variation 4.

As shown in FIGS. 13 and 14, during the maintenance period after the discharge period, the controller 21 controls the robotic arm 100 to change the posture of the droplet discharge head 300 to a posture P₂ in which the recovery port 322 is located higher than the supply port 321.

As described above, in Variation 5, when the posture of the droplet discharge head 300 is changed to the posture in which the recovery port 322 is located higher than the supply port 321, air bubbles remaining in the droplet discharge head 300 can be efficiently moved in the direction opposite to the direction of gravitational force. As a result, in Variation 5, since the movement of the air bubbles in the direction from the supply port 321 toward the recovery port 322 can be promoted, the air bubbles can be smoothly discharged from the recovery port 322 to the outside of the droplet discharge head 300.

The examples in FIGS. 13 and 14 are examples in which the posture of the droplet discharge head 300 is changed to the posture in which the recovery port 322 is located higher than the supply port 321. However, the height positions of the supply port 321 and the recovery port 322 may be reversed. That is, the controller 21 may change the posture of the droplet discharge head 300 to a posture in which the supply port 321 is located higher than the recovery port 322. In this case, solidified substances of the coloring liquid remaining in the droplet discharge head 300 can be efficiently moved in the direction of gravitational force. As a result, since the movement of the solidified substances of the coloring liquid in the direction from the supply port 321 toward the recovery port 322 can be promoted, the solidified substances of the coloring liquid can be smoothly discharged from the recovery port 322 to the outside of the droplet discharge head 300.

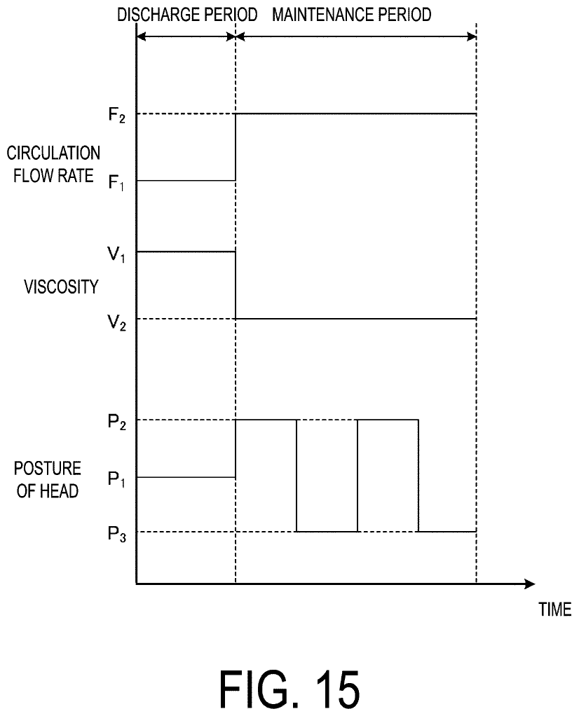

FIG. 15 is an explanatory diagram for describing a mode of adjusting the circulation flow rate according to Variation 6 of the embodiment. Variation 6 relates to a variation of the posture change of the droplet discharge head 300 in Variation 5.

As shown in FIG. 15, during the maintenance period after the discharge period, the controller 21 changes the posture of the droplet discharge head 300 between the posture P₂ in which the recovery port 322 is located higher than the supply port 321 and a posture P₃ in which the supply port 321 is located higher than the recovery port 322.

As described above, since the posture of the droplet discharge head 300 is changed between the posture in which the recovery port 322 is located relatively high and the posture in which the supply port 321 is located relatively high, the movement of the solidified substances and air bubbles of the coloring liquid between the supply port 321 and the recovery port 322 can be promoted. As a result, according to Variation 6, the solidified substances and air bubbles of the coloring liquid can be smoothly discharged from the recovery port 322 to the outside of the droplet discharge head 300.

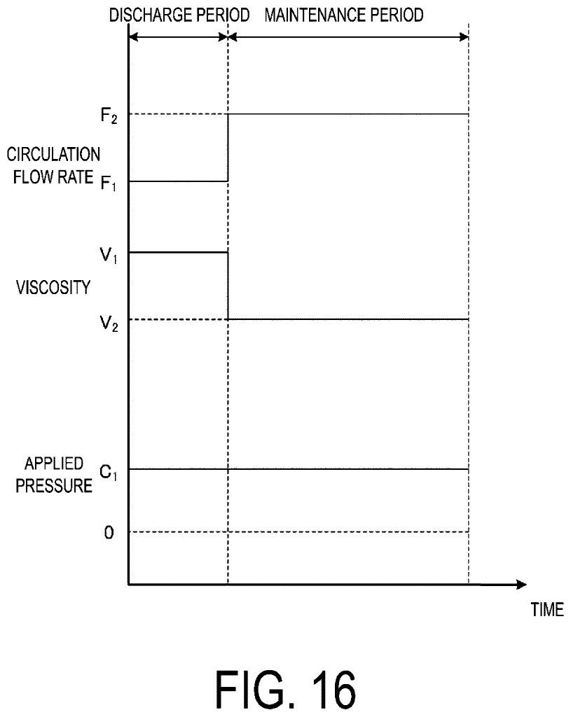

FIG. 16 is an explanatory diagram for describing a mode of adjusting the circulation flow rate according to Variation 7 of the embodiment. FIG. 16 shows temporal change of “applied pressure” in the discharge period and the maintenance period. The term “applied pressure” refers to pressure applied from the displacement element 353 to the pressurizing chamber 352 in the droplet discharge head 300.

As shown in FIG. 16, during the maintenance period after the discharge period, the controller 21 controls the circulation mechanism 200 to cause the displacement element 353 to apply pressure to the pressurizing chamber 352 while increasing the circulation flow rate of the coloring liquid.

For example, the controller 21 applies a pressure C₁ to the pressurizing chamber 352 by the displacement element 353 during the discharge period and maintains the application of the pressure from the displacement element 353 to the pressurizing chamber 352 while increasing the circulation flow rate to the circulation flow rate F₂ (>F₁) during the maintenance period. Thus, during the maintenance period, the controller 21 can reduce the viscosity of the coloring liquid supplied to the droplet discharge head 300 from the viscosity V₁ of the coloring liquid in the discharge period to the viscosity V₂ (<V₁).

As described above, during the maintenance period after the discharge period, pressure is applied to the pressurizing chamber 352 while increasing the circulation flow rate of the coloring liquid, and thus a pressure wave can be generated in the pressurizing chamber 352 while reducing the viscosity of the coloring liquid supplied to the droplet discharge head 300.

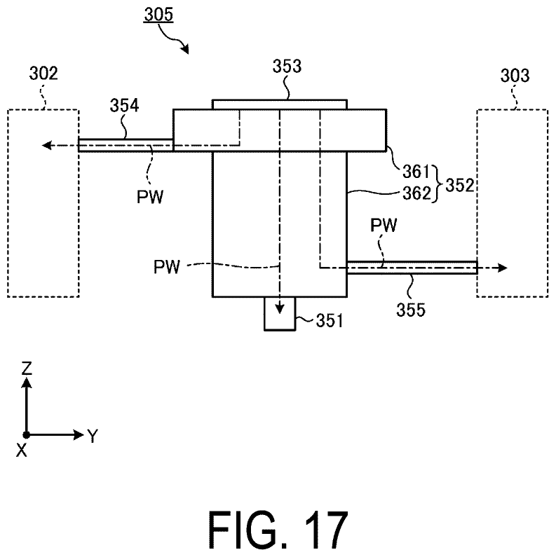

According to Variation 7, since the viscosity of the coloring liquid is reduced, the difference between the viscosity of the coloring liquid flowing through the pressurizing chamber 352 and the viscosity of the coloring liquid flowing through the supply manifold 302 and the recovery manifold 303 (hereinafter collectively referred to as “manifolds”) that are connected to the pressurizing chamber 352 can be reduced. Since the difference between the viscosity of the coloring liquid flowing through the pressurizing chamber 352 and the viscosity of the coloring liquid flowing through the manifolds is reduced, as illustrated in FIG. 17, a pressure wave PW generated in the pressurizing chamber 352 is easily transmitted not only to the pressurizing chamber 352 but also to the manifolds. FIG. 17 is a diagram illustrating propagation of the pressure wave according to Variation 7 of the embodiment. As described above, the pressure wave PW generated in the pressurizing chamber 352 is propagated to the manifolds, and thus residue remaining in the manifolds can be concentratively removed by the pressure wave PW.

The example in FIG. 16 is an example in which the pressure applied to the pressurizing chamber 352 during the discharge period and the pressure applied to the pressurizing chamber 352 during the maintenance period are both the pressure C₁. However, the pressure applied to the pressurizing chamber 352 during the maintenance period may be lower than the pressure applied to the pressurizing chamber 352 during the discharge period (i.e., the pressure for discharging the coloring liquid from the nozzle 351).

### Variation of Mode of Circulating Coloring Liquid

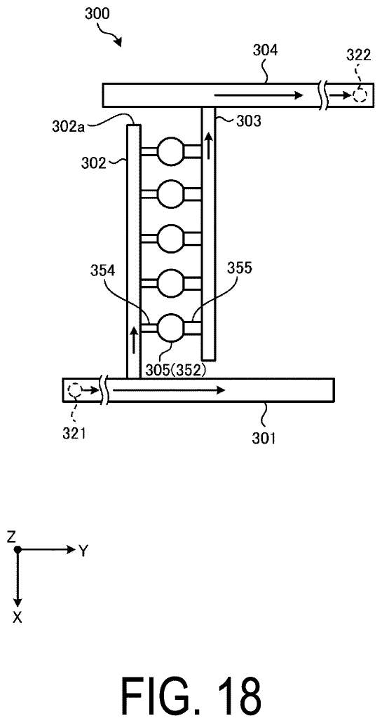

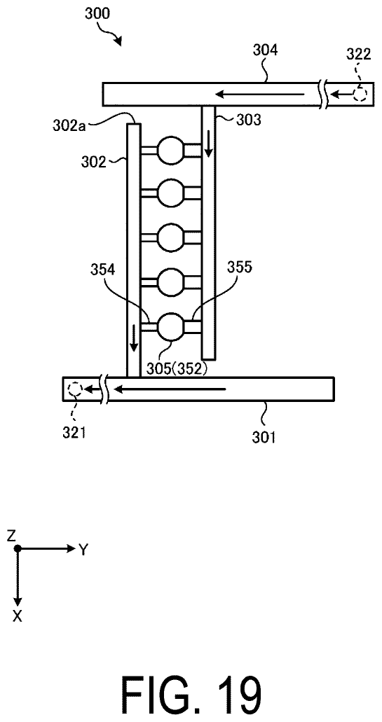

Next, a variation of a mode of circulating the coloring liquid according to the embodiment will be described with reference to FIGS. 18 and 19.

FIGS. 18 and 19 are explanatory diagrams for describing an internal configuration of the droplet discharge head 300 according to Variation 8 of the embodiment and the mode of circulating the coloring liquid.

In the droplet discharge head 300 illustrated in FIGS. 18 and 19, a channel resistance of the separate recovery channel 355 connecting the pressurizing chamber 352 and the recovery manifold 303 of the discharge unit 305 is smaller than a channel resistance of the separate supply channel 354 connecting the pressurizing chamber 352 and the supply manifold 302. For example, the channel width of the separate recovery channel 355 is set to be larger than the channel width of the separate supply channel 354, and thus the channel resistance of the separate recovery channel 355 can be made smaller than the channel resistance of the separate supply channel 354.

During the maintenance period after the discharge period, the controller 21 controls the circulation mechanism 200 to circulate the coloring liquid from the recovery port 322 toward the supply port 321. For example, in the first period included in the maintenance period, as illustrated in FIG. 18, the controller 21 controls the circulation mechanism 200 to circulate the coloring liquid from the supply port 321 toward the recovery port 322. Then, in the second period included in the maintenance period and subsequent to the first period, for example, as illustrated in FIG. 19, the controller 21 controls the circulation mechanism 200 to reverse the flow direction of the coloring liquid and circulate the coloring liquid from the recovery port 322 toward the supply port 321.

In Variation 8, the circulation direction (flow direction) of the coloring liquid is changed from the direction from the supply port 321 toward the recovery port 322 to the direction from the recovery port 322 toward the supply port 321. Accordingly, in Variation 8, the coloring liquid flows through the recovery reservoir 304, the recovery manifold 303, the separate recovery channel 355, the discharge unit 305, the separate supply channel 354, the supply manifold 302, and the supply reservoir 301 in this order. Here, the channel resistance of the separate recovery channel 355 is smaller than the channel resistance of the separate supply channel 354. Accordingly, the shear rate of the coloring liquid increases and the viscosity of the coloring liquid decreases in the separate recovery channel 355, and the coloring liquid having the decreased viscosity flows via the discharge unit 305 and the separate supply channel 354 into the supply manifold 302 and reaches a tip portion 302a of the supply manifold 302. As a result, according to Variation 8, the coloring liquid remaining in the tip portion 302a of the supply manifold 302 and having a relatively high viscosity can be replaced with the coloring liquid having a relatively low viscosity.

### Other Variations

In the embodiment, an example in which the circulation mechanism 200 supplies the coloring liquid to the droplet discharge head 300 is described. However, the supply unit that supplies the coloring liquid to the droplet discharge head 300 is not limited to the circulation mechanism 200. For example, the supply unit may be a liquid supply mechanism including a plurality of liquid supply sources that respectively supply a plurality of coloring liquids having different viscosities, supply channels that connect the plurality of liquid supply sources to the droplet discharge head 300, and on-off valves respectively disposed in the supply channels for the liquid supply sources. When the supply unit is such a liquid supply mechanism, the controller 21 may control the on-off valves of the liquid supply mechanism during at least a part of the maintenance period after the discharge period to supply the coloring liquid having a viscosity lower than that of the coloring liquid in the discharge period to the droplet discharge head 300. In such a case, the coloring liquid may not be a pseudoplastic fluid. Also in such a case, the droplet discharge head 300 may include at least the nozzle 351, the pressurizing chamber 352 connected to the nozzle 351, and an actuator (the displacement element 353) that applies pressure to the pressurizing chamber 352.

As described above, the droplet discharge device (e.g., the droplet discharge device 1) according to the embodiment includes a droplet discharge head (e.g., the droplet discharge head 300), a supply unit (e.g., the circulation mechanism 200), and a controller (e.g., the controller 21). The droplet discharge head discharges droplets of the coloring liquid. The supply unit supplies the coloring liquid to the droplet discharge head. The controller controls each unit. During at least a part of the maintenance period after the discharge period in which droplets of the coloring liquid are discharged from the droplet discharge head, the controller controls the supply unit to supply the coloring liquid having a viscosity lower than that of the coloring liquid in the discharge period to the droplet discharge head. As a result, the droplet discharge device according to the embodiment can suppress discharge failure caused by residue in the droplet discharge head.

The coloring liquid may be a pseudoplastic fluid whose viscosity decreases as the shear rate increases. The supply unit may be a circulation mechanism (e.g., the circulation mechanism 200) that supplies the coloring liquid to the droplet discharge head while controlling the circulation flow rate of the coloring liquid circulating between the supply unit and the droplet discharge head. During at least a part of the maintenance period, the controller may control the circulation mechanism to increase the circulation flow rate of the coloring liquid to be higher than the circulation flow rate of the coloring liquid in the discharge period. As described above, during the maintenance period after the discharge period, the circulation flow rate of the coloring liquid is increased to be higher than the circulation flow rate of the coloring liquid in the discharge period, and thus the viscosity of the coloring liquid can be reduced compared to the viscosity of the coloring liquid in the discharge period. As a result, the droplet discharge device according to the embodiment can easily peel off residue from the inner wall of the channel within the droplet discharge head.

The controller may control the circulation mechanism to change the circulation flow rate of the coloring liquid between the first period and the second period subsequent to the first period, which are included in the maintenance period. With the circulation flow rate of the coloring liquid changed as described, the coloring liquid having a relatively low viscosity and the coloring liquid having a relatively high viscosity can be supplied to the droplet discharge head. As a result, according to the droplet discharge device of the embodiment, residue can be peeled off from the inner wall of the channel within the droplet discharge head by the coloring liquid having a relatively low viscosity, and residue remaining in the droplet discharge head can be washed away by the coloring liquid having a relatively high viscosity.

The controller may control the circulation mechanism to set the circulation flow rate of the coloring liquid to the first flow rate in the first period and to the second flow rate lower than the first flow rate in the second period. As a result, with the droplet discharge device according to the embodiment, residue can be peeled off from the inner wall of the channel within the droplet discharge head by the coloring liquid having a relatively low viscosity, and then the residue remaining in the droplet discharge head can be washed away by the coloring liquid having a relatively high viscosity.

The controller may control the circulation mechanism to set the circulation flow rate of the coloring liquid to a first flow rate in the first period and to a second flow rate higher than the first flow rate in the second period. As a result, with the droplet discharge device according to the embodiment, residue remaining in the droplet discharge head can be washed away by the coloring liquid having a relatively high viscosity and then the residue can be transported at high speed by the coloring liquid having a relatively low viscosity to the downstream side of the channel within the droplet discharge head.

During the maintenance period, the controller may control the circulation mechanism to stop the circulation of the coloring liquid for a predetermined time and then increase the circulation flow rate of the coloring liquid. Thus, when the coloring liquid contains a dissolving component capable of dissolving the solidified substances of the coloring liquid, the droplet discharge device according to the embodiment enables the solidified substances remaining in the droplet discharge head to be dissolved in the dissolving component contained in the coloring liquid, and the solidified substances that have been dissolved can be transported at a high speed by the coloring liquid to the downstream side of the channel within the droplet discharge head. The predetermined time may be, for example, a time required for the solidified substances remaining in the droplet discharge head to be dissolved in the dissolving component, but may be shorter or longer than that time.

The droplet discharge device according to the embodiment may further include a robotic arm (e.g., the robotic arm 100). The robotic arm is provided with the droplet discharge head such that the posture of the droplet discharge head is changeable. During at least a part of the maintenance period, the controller may control the circulation mechanism to increase the circulation flow rate of the coloring liquid, and may control the robotic arm to change the posture of the droplet discharge head. As a result, the droplet discharge device according to an embodiment can promote the movement of residue in the direction of gravitational force and in the direction opposite to the direction of gravitational force, and thus the residue can be smoothly discharged to the outside of the droplet discharge head.

The controller may change the posture of the droplet discharge head at the timing when the circulation flow rate of the coloring liquid is increased. As a result, the droplet discharge device according to an embodiment can further promote the movement of residue in the direction of gravitational force and in the direction opposite to the direction of gravitational force, and thus the residue can be more smoothly discharged to the outside of the droplet discharge head.

The droplet discharge head may include a supply port (e.g., the supply port 321) for supplying the coloring liquid to the inside of the droplet discharge head and a recovery port (e.g., the recovery port 322) for recovering the coloring liquid from the inside of the droplet discharge head. The controller may change the posture of the droplet discharge head to a posture in which one of the supply port and the recovery port is located higher than the other. As a result, the droplet discharge device according to the embodiment can smoothly discharge the solidified substances or air bubbles of the coloring liquid from the recovery port to the outside of the droplet discharge head.

The controller may change the posture of the droplet discharge head between a posture in which one of the supply port and the recovery port is located higher than the other and a posture in which the other of the supply port and the recovery port is located higher than the one. As a result, the droplet discharge device according to the embodiment can smoothly discharge the solidified substances and air bubbles of the coloring liquid from the recovery port to the outside of the droplet discharge head.

The droplet discharge head may include a discharge unit (e.g., the discharge unit 305), a supply manifold (e.g., the supply manifold 302), and a recovery manifold (e.g., the recovery manifold 303). The discharge unit may include a nozzle (e.g., the nozzle 351), a pressurizing chamber (e.g., the pressurizing chamber 352), and a pressurizing unit (e.g., the displacement element 353). The pressurizing chamber is connected to the nozzle. The pressurizing unit applies pressure to the pressurizing chamber to discharge droplets of the coloring liquid from the nozzle. The supply manifold is connected to the pressurizing chamber and is configured to supply the coloring liquid to the pressurizing chamber. The recovery manifold is connected to the pressurizing chamber and is configured to recover the coloring liquid from the pressurizing chamber. During at least a part of the maintenance period, the controller may control the circulation mechanism to cause the pressurizing unit to apply pressure to the pressurizing chamber while increasing the circulation flow rate of the coloring liquid. Accordingly, the difference between the viscosity of the coloring liquid flowing through the pressurizing chamber and the viscosity of the coloring liquid flowing through the manifold connected to the pressurizing chamber can be reduced, and thus a pressure wave generated in the pressurizing chamber is easily transmitted not only to the pressurizing chamber but also to the manifold. As a result, the droplet discharge device according to the embodiment can concentratively remove the residue remaining in the manifold by the pressure wave.

The droplet discharge head may include a discharge unit (e.g., the discharge unit 305), a supply manifold (e.g., the supply manifold 302), and a recovery manifold (e.g., the recovery manifold 303). The discharge unit may include a nozzle (e.g., the nozzle 351), a pressurizing chamber (e.g., the pressurizing chamber 352), and a pressurizing unit (e.g., the displacement element 353). The pressurizing chamber is connected to the nozzle. The pressurizing unit applies pressure to the pressurizing chamber to discharge droplets of the coloring liquid from the nozzle. The supply manifold is connected to the pressurizing chamber and is configured to supply the coloring liquid supplied from a supply port (e.g., the supply port 321) side of the droplet discharge head, to the pressurizing chamber. The recovery manifold is connected to the pressurizing chamber and is configured to recover the coloring liquid from the pressurizing chamber and send out the coloring liquid to a recovery port (e.g., the recovery port 322) side of the droplet discharge head. The pressurizing chamber and the supply manifold may be connected to each other via a separate supply channel (e.g., the separate supply channel 354). The pressurizing chamber and the recovery manifold may be connected to each other via a separate recovery channel (e.g., the separate recovery channel 355). The channel resistance of the separate recovery channel may be smaller than the channel resistance of the separate supply channel. During at least a part of the maintenance period, the controller may control the circulation mechanism to circulate the coloring liquid from the recovery port toward the supply port. As a result, the droplet discharge device according to an embodiment can replace the coloring liquid having relatively high viscosity and remaining in a tip portion (e.g., the tip portion 302a) of the supply manifold with the coloring liquid having relatively low viscosity.

Further effects and variations can be readily derived by those skilled in the art. Thus, a wide variety of aspects of the present invention are not limited to the specific details and representative embodiments represented and described above. Accordingly, various changes can be made without departing from the spirit or scope of the general inventive concepts defined by the appended claims and their equivalents.

### REFERENCE SIGNS

1 Droplet discharge device
2 Control device
10 Base
21 Controller
22 Storage
50 Object
100 Robotic arm
110 Arm portion
200 Circulation mechanism
201 Tank
202 Discharge pump
203 Suction pump
204 First proportional valve
205 Second proportional valve
206 Heater
208 First pressure sensor
209 Second pressure sensor
210 Third pressure sensor
211 Fourth pressure sensor
212 Flowmeter
300 Droplet discharge head
301 Supply reservoir
302 Supply manifold
303 Recovery manifold
304 Recovery reservoir
305 Discharge unit
321 Supply port
322 Recovery port
351 Nozzle
352 Pressurizing chamber
353 Displacement element
354 Separate supply channel
355 Separate recovery channel
361 Body portion
362 Descender

1. A droplet discharge device, comprising:
a droplet discharge head configured to discharge droplets of a coloring liquid;
a supply unit configured to supply the coloring liquid to the droplet discharge head; and
a controller configured to control each unit, wherein
during at least a part of a maintenance period after a discharge period in which droplets of the coloring liquid are discharged from the droplet discharge head, the controller controls the supply unit to supply the coloring liquid having a lower viscosity than that of the coloring liquid in the discharge period to the droplet discharge head.

2. The droplet discharge device according to claim 1, wherein
the coloring liquid is a pseudoplastic fluid whose viscosity decreases as a shear rate increases,
the supply unit is a circulation mechanism configured to supply the coloring liquid to the droplet discharge head while controlling a circulation flow rate of the coloring liquid circulating between the supply unit and the droplet discharge head, and
during at least a part of the maintenance period, the controller controls the circulation mechanism to increase the circulation flow rate of the coloring liquid to be higher than the circulation flow rate of the coloring liquid in the discharge period.

3. The droplet discharge device according to claim 2, wherein the controller controls the circulation mechanism to change the circulation flow rate of the coloring liquid between a first period and a second period subsequent to the first period, the first period and the second period being included in the maintenance period.

4. The droplet discharge device according to claim 3, wherein the controller controls the circulation mechanism to set the circulation flow rate of the coloring liquid to a first flow rate in the first period and to a second flow rate lower than the first flow rate in the second period.

5. The droplet discharge device according to claim 3, wherein the controller controls the circulation mechanism to set the circulation flow rate of the coloring liquid to a first flow rate in the first period and to a second flow rate higher than the first flow rate in the second period.

6. The droplet discharge device according to claim 2, wherein the controller controls the circulation mechanism in the maintenance period to stop circulation of the coloring liquid for a predetermined time and then increase the circulation flow rate of the coloring liquid.

7. The droplet discharge device according to claim 2, further comprising:
a robotic arm on which the droplet discharge head is mounted such that a posture of the droplet discharge head is changeable, wherein
during at least a part of the maintenance period, the controller controls the circulation mechanism to increase the circulation flow rate of the coloring liquid and controls the robotic arm to change the posture of the droplet discharge head.

8. The droplet discharge device according to claim 7, wherein the controller changes the posture of the droplet discharge head at a timing when the circulation flow rate of the coloring liquid is increased.

9. The droplet discharge device according to claim 7, wherein
the droplet discharge head comprises:
a supply port for supplying the coloring liquid to the inside of the droplet discharge head; and
a recovery port for recovering the coloring liquid from the inside of the droplet discharge head, and
the controller changes the posture of the droplet discharge head to a posture in which one of the supply port and the recovery port is located higher than the other.

10. The droplet discharge device according to claim 9, wherein the controller changes the posture of the droplet discharge head between a posture in which one of the supply port and the recovery port is located higher than the other and a posture in which the other of the supply port and the recovery port is located higher than the one.

11. The droplet discharge device according to claim 2, wherein
the droplet discharge head comprises:
a discharge unit comprising a nozzle, a pressurizing chamber connected to the nozzle, and a pressurizing unit configured to apply pressure to the pressurizing chamber to discharge droplets of the coloring liquid from the nozzle;
a supply manifold connected to the pressurizing chamber and configured to supply the coloring liquid to the pressurizing chamber; and
a recovery manifold connected to the pressurizing chamber and configured to recover the coloring liquid from the pressurizing chamber, and
during at least a part of the maintenance period, the controller controls the circulation mechanism to cause the pressurizing unit to apply pressure to the pressurizing chamber while increasing the circulation flow rate of the coloring liquid.

12. The droplet discharge device according to claim 1, wherein
the coloring liquid is a pseudoplastic fluid whose viscosity decreases as a shear rate increases,
the supply unit is a circulation mechanism configured to supply the coloring liquid to the droplet discharge head while controlling a circulation flow rate of the coloring liquid circulating between the supply unit and the droplet discharge head,
the droplet discharge head comprises:
a discharge unit comprising a nozzle, a pressurizing chamber connected to the nozzle, and a pressurizing unit configured to apply pressure to the pressurizing chamber to discharge droplets of the coloring liquid from the nozzle;
a supply manifold connected to the pressurizing chamber and configured to supply, to the pressurizing chamber, the coloring liquid supplied from a supply port side of the droplet discharge head; and
a recovery manifold connected to the pressurizing chamber and configured to recover the coloring liquid from the pressurizing chamber and send out the coloring liquid to a recovery port side of the droplet discharge head,
the pressurizing chamber and the supply manifold are connected to each other via a separate supply channel,
the pressurizing chamber and the recovery manifold are connected to each other via a separate recovery channel,
a channel resistance of the separate recovery channel is smaller than a channel resistance of the separate supply channel, and
during at least a part of the maintenance period, the controller controls the circulation mechanism to circulate the coloring liquid from the recovery port toward the supply port.

13. A maintenance method for a droplet discharge device comprising:
a droplet discharge head configured to discharge droplets of a coloring liquid; and
a supply mechanism configured to supply the coloring liquid to the droplet discharge head, the maintenance method comprising:
during at least a part of a maintenance period after a discharge period in which droplets of the coloring liquid are discharged from the droplet discharge head, controlling the supply mechanism to supply the coloring liquid having a lower viscosity than that of the coloring liquid in the discharge period to the droplet discharge head.
